(19) United States
(12) Patent Application Publication
(10) Pub. No.: US 2026/0239337 A1
(43) Pub. Date: Aug. 13, 2026

(54) REPETITIONS OF UPLINK TRANSMISSION

(71) Applicant: Nokia Technologies Oy, Espoo (FI)

(72) Inventors: Nhat-Quang NHAN, Massy (FR); Marco MASO, Massy (FR); Claudio ROSA, Aalborg (DK); Guillermo POCOVI, Aalborg (DK); Youngsoo YUK, Seoul (KR); Jing Yuan SUN, Beijing (CN)

(21) Appl. No.: 19/155,765

(22) PCT Filed: Feb. 17, 2023
(86) PCT No.: PCT/CN2023/076984

§ 371 Date: Aug. 12, 2025

(51) Int. Cl. H04W 72/1268; H04L 1/08

(52) U.S. Cl. CPC H04W 72/1268; H04L 1/08

(57) ABSTRACT

Embodiments of the present disclosure relate to method of repetitions of an uplink transmission. A terminal device receives, from a network device, scheduling information scheduling an uplink transmission to be transmitted by the terminal device using a repetition type, and determines, based on a repetition type, a first set of resources for a first repetition among a plurality of repetitions of the uplink transmission and a second set of resources for a second repetition among the plurality of repetitions, wherein the first set of resources are in a first number of slots with a first slot type and the second set of resources are in a second number of slots with a second slot type; and transmit, to the network device, the plurality of repetitions. The solution enables enhancements for improving coverage of uplink transmissions.

### FIELD

Various example embodiments relate to the field of telecommunication and in particular, to a method, device, apparatus and computer readable storage medium for repetitions of an uplink transmission.

### BACKGROUND

In the communications area, there is a constant evolution ongoing in order to provide efficient and reliable solutions for utilizing wireless communication networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

3GPP Rel-15 introduces a slot aggregation feature for physical uplink shared channel (PUSCH), which is also known as PUSCH repetition type A. Rel-16 allows to dynamically indicate number of repetitions for PUSCH repetition type A by associating the number of repetitions to each row of time domain resource assignment (TDRA) table. Rel-17 further improves PUSCH repetition type A by allowing the number of repetitions to be counted on available slots. Furthermore, Rel-17 coverage enhancement WI specifies a feature called transport block processing over multiple slots (TBoMS). This feature allows mapping a single transport block (TB) over multiple slots.

### SUMMARY

In general, example embodiments of the present disclosure provide a solution for repetitions of an uplink transmission.

In a first aspect, there is provided a terminal device. The terminal device comprises at least one processor and at least one memory storing instructions that, when executed by the at least one processor, cause the terminal device at least to: receive, from a network device, scheduling information scheduling an uplink transmission to be transmitted by the terminal device using a repetition type; determine, based on the repetition type, a first set of resources for a first repetition among a plurality of repetitions of the uplink transmission and a second set of resources for a second repetition among the plurality of repetitions, wherein the first set of resources are in a first number of slots with a first slot type and the second set of resources are in a second number of slots with a second slot type; and transmit, to the network device, the plurality of repetitions of the uplink transmission.

In a second aspect, there is provided a network device. The network device comprises at least one processor and at least one memory storing instructions that, when executed by the at least one processor, cause the network device at least to: transmit, to the terminal device, scheduling information which schedules an uplink transmission to be transmitted by the terminal device using a repetition type; and receive, from the terminal device, a plurality of repetitions of the uplink transmission comprising a first repetition and a second repetition, wherein a first set of resources for the first repetition are in a first number of slots with a first slot type and a second set of resources for the second repetition are in a second number of slots with a second slot type.

In a third aspect, there is provided a method. The method comprises receiving, at a terminal device and from a network device, scheduling information scheduling an uplink transmission to be transmitted by the terminal device using a repetition type; determining, based on the repetition type, a first set of resources for a first repetition among a plurality of repetitions of the uplink transmission and a second set of resources for a second repetition among the plurality of repetitions, wherein the first set of resources are in a first number of slots with a first slot type and the second set of resources are in a second number of slots with a second slot type; and transmitting, to the network device, the plurality of repetitions of the uplink transmission.

In a fourth aspect, there is provided a method. The method comprises transmitting, at a network device and to a terminal device, scheduling information which schedules an uplink transmission to be transmitted by the terminal device using a repetition type; and receiving, from the terminal device, a plurality of repetitions of the uplink transmission comprising a first repetition and a second repetition, wherein a first set of resources for the first repetition are in a first number of slots with a first slot type and a second set of resources for the second repetition are in a second number of slots with a second slot type.

In a fifth aspect, there is provided an apparatus. The apparatus comprises means for receiving, at a terminal device and from a network device, scheduling information scheduling an uplink transmission to be transmitted by the terminal device using a repetition type; means for determining, based on the repetition type, a first set of resources for a first repetition among a plurality of repetitions of the uplink transmission and a second set of resources for a second repetition among the plurality of repetitions, wherein the first set of resources are in a first number of slots with a first slot type and the second set of resources are in a second number of slots with a second slot type; and means for transmitting, to the network device, the plurality of repetitions of the uplink transmission.

In a sixth aspect, there is provided an apparatus. The apparatus comprises means for transmitting, at a network device and to a terminal device, scheduling information which schedules an uplink transmission to be transmitted by the terminal device using the repetition type; and means for receiving, from the terminal device, a plurality of repetitions of the uplink transmission comprising a first repetition and a second repetition, wherein a first set of resources for the first repetition are in a first number of slots with a first slot type and a second set of resources for the second repetition are in a second number of slots with a second slot type.

In a seventh aspect, there is provided a non-transitory computer readable medium comprising program instructions for causing an apparatus to perform at least the method according to any one of the above third to fourth aspect.

In an eighth aspect, there is provided a non-transitory computer readable medium comprising program instructions stored thereon for performing at least the method according to any one of the above third to fourth aspect.

In a ninth aspect, there is provided a computer program comprising instructions, which, when executed by an apparatus, cause the apparatus at least to: receive, from a network device, scheduling information scheduling an uplink transmission to be transmitted by a terminal device using a repetition type; determine, based on the repetition type, a first set of resources for a first repetition among a plurality of repetitions of the uplink transmission and a second set of resources for a second repetition among the plurality of repetitions, wherein the first set of resources are in a first number of slots with a first slot type and the second set of resources are in a second number of slots with a second slot type; and transmit, to the network device, the plurality of repetitions of the uplink transmission.

In a tenth aspect, there is provided a computer program comprising instructions, which, when executed by an apparatus, cause the apparatus at least to: transmit, to a terminal device, scheduling information which schedules an uplink transmission to be transmitted by the terminal device using a repetition type; and receive, from the terminal device, a plurality of repetitions of the uplink transmission comprising a first repetition and a second repetition, wherein a first set of resources for the first repetition are in a first number of slots with a first slot type and a second set of resources for the second repetition are in a second number of slots with a second slot type.

In an eleventh aspect, there is provided a terminal device. The terminal device comprises: receiving circuitry configured to receive, from a network device, scheduling information scheduling an uplink transmission to be transmitted by the terminal device using a repetition type; determining circuitry configured to determine, based on the repetition type, a first set of resources for a first repetition among a plurality of repetitions of the uplink transmission and a second set of resources for a second repetition among the plurality of repetitions, wherein the first set of resources are in a first number of slots with a first slot type and the second set of resources are in a second number of slots with a second slot type; and transmitting circuitry configured to transmit, to the network device, the plurality of repetitions of the uplink transmission.

In a twelfth aspect, there is provided a network device. The network device comprises: transmitting circuitry configured to transmit, to a terminal device, scheduling information which schedules an uplink transmission to be transmitted by the terminal device using a repetition type; and receiving circuitry configured to receive, from the terminal device, a plurality of repetitions of the uplink transmission comprising a first repetition and a second repetition, wherein a first set of resources for the first repetition are in a first number of slots with a first slot type and a second set of resources for the second repetition are in a second number of slots with a second slot type.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication system in which embodiments of the present disclosure may be implemented;

FIG. 1B illustrates a schematic diagram illustrating SBFD and non-SBFD slots;

FIG. 1C illustrates a schematic diagram illustrating frequency-time resource partitioning with SBFD as compared to FDD and TDD;

FIG. 1D and FIG. 1E illustrate schematic diagrams illustrating Co-channel interference types in SBFD deployment;

FIG. 1F illustrates schematic diagrams illustrating power spectral density gain offered by TBoMS compared to single-slot PUSCH for the same TBS;

FIG. 2 illustrates a schematic diagram illustrating a process of communication between a terminal device and a network device according to some embodiments of the present disclosure;

FIG. 3 illustrates a schematic diagram illustrating a repetition type for SBFD operation according to the present disclosure;

FIG. 4 illustrates a schematic diagram illustrating a process of communication between a terminal device and a network device according to some other embodiments of the present disclosure;

FIG. 5 illustrates a schematic diagram illustrating a method implemented at a terminal device according to some other embodiments of the present disclosure;

FIG. 6 illustrates a schematic diagram illustrating a method implemented at a network device according to some other embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

3GPP Rel-15 introduces a slot aggregation feature for physical uplink shared channel (PUSCH), which is also known as PUSCH repetition type A. In this feature, transmission of a transport block is repeated in multiple slots. The key design aspects of PUSCH repetition type A in Rel-15 comprises:

Resource allocation: The same resource allocation is applied across the PUSCH repetitions. For time domain: Each repetition is in a slot. Only a single starting and length of a PUSCH within a slot is indicated, i.e., a single start and length indicator value (SLIV). The same start and length indicated by the single SLIV is applied across all PUSCH repetitions. In Rel-15, the number of repetitions for PUSCH repetitions type A is semi-statically configured in RRC (radio resource control) and the number of repetitions is counted on consecutive physical slots. If the number of available symbols in a slot is not sufficient (<L), PUSCH repetition is not transmitted in the slot. For frequency domain: The PUSCH repetitions have the same frequency domain resource allocation (i.e., the same number of physical resource blocks (PRBs) and the same location of these PRBs in frequency domain).

Transport block size (TBS) determination: The unquantized intermediate variable (NInfo) for the calculation of TBS for PUSCH repetition type A is calculated based on the number of REs determined in a slot.

Rate-matching: The same or different redundancy version (RV) of the encoded bits in circular buffer can be applied for each PUSCH repetition. RV for the first repetition can be indicated by scheduling DCI (downlink control information) for dynamic grant or preconfigured for configured grant. If different RVs are applied, RVs are cycled from a configured RV sequence, following the indicated RV for the first repetition. There are four RVs, each provides information on the starting encoded bit from circular buffer that UE should map to a PUSCH transmission associated with the RV.

Rel-16 allows to dynamically indicate number of repetitions for PUSCH repetition type A by associating the number of repetitions to each row of time domain resource assignment (TDRA) table. Furthermore, Rel-16 also introduces PUSCH repetition type B for ultra-reliable low latency (URLLC) applications. In this feature, single SLIV is used for determining multiple back-to-back nominal repetitions with the same length and each nominal repetition can span across the slot boundary. Then, each nominal repetition is split into multiple actual repetitions if it crosses the slots boundary or invalid symbols. The PUSCH repetitions in PUSCH repetition type B also have the same frequency domain resource allocation.

Rel-17 further improves PUSCH repetition type A by allowing the number of repetitions to be counted on available slots, i.e., only on the slots that are available for the transmissions of the repetitions. Rel-17 also increases the maximum number of repetitions from 16 to 32 for PUSCH repetition type A.

Rel-17 coverage enhancement WI specifies a feature called transport block processing over multiple slots (TBoMS). This feature allows mapping a single transport block (TB) over multiple slots, i.e., resource allocation for a single PUSCH transmission can span across multiple slots. This is different from PUSCH repetitions.

Some key design aspects of TBoMS can be summarized as follows:

Resource allocation: For time domain: A new column is added in TDRA table for indicating the number of slots allocated for TBoMS (Nₛₗₒₜ). Nₛₗₒₜ is counted on available slots (following Rel-17 rules of counting on available slots for PUSCH repetition type A). Hence, non-consecutive slots can be used for TBoMS in TDD (time division duplexing). The same starting symbol(S) and length (L) for the resource in each slot allocated for TBoMS (similar to repetition type A). For Frequency domain: The same number of PRBs is allocated across slots for TBoMS transmission (similar to repetition type A).

TBS determination: NInfo for TBoMS is calculated based on the number of REs determined in the first slot allocated for TBOMS scaled by Nₛₗₒₜ, where Nₛₗₒₜ is the number of slots allocated for TBoMS. In other words, the TBS for TBoMS is calculated based on the total resource allocated for TBoMS across multiple slots.

Rate-matching: Only a single redundancy version is used for a single TBoMS (i.e., no RV cycling within a single TBoMS). Bit selection from circular buffer and bit interleaving are performed per slot. For bit selection in a slot, the index of the starting coded bit in the circular buffer is the index continuous from the position of the last bit selected in the previous allocated slot, regardless of whether UCI (uplink control information) multiplexing occurred in the previous allocated slot or not. TBoMS transmission is limited to one code block only.

Repetition of a single TBoMS: Repetitions of a single TBoMS is supported. The column in TDRA table that indicates number of repetitions for Rel-17 PUSCH repetition type A (i.e., numberOfRepetitions-r17) is used for indicating also the number of repetitions of a single TBoMS (Nᵣₑₚ). The UE determines Nᵣₑₚ*Nₛₗₒₜ available slots for TBoMS repetition, same S & L on each slot, but TBS will be calculated by the resource of a single TBoMS (i.e., scaled by Nₛₗₒₜ). Redundancy versions (RVs) are cycled across the TBoMS repetitions. The legacy Rel-15/16 RV sequences and RV index indication are reused.

Rel-18 study item on duplexing evolution, including subband non-overlapping full duplex (SBFD). 3GPP 5G NR currently supports two duplexing modes: FDD (frequency division duplexing) for paired bands and TDD for unpaired bands. In TDD, the time domain resource is split between downlink and uplink. Allocation of a limited time duration for the uplink in TDD would result in reduced coverage, increased latency, and reduced capacity.

Motivated by this, 3GPP has agreed to initiate a Rel-18 study item (RP-213591) on the evolution of duplexing operation in NR that addresses the challenges above. One of the objectives of the study item is to allow simultaneous DL (downlink) and UL (uplink) transmission on different physical resource blocks (PRBs)/subbands within an unpaired wideband NR cell. This may be referred to as subband non-overlapping full duplex (SBFD). In other sources, this duplexing scheme is also referred to as cross division duplexing (xDD) scheme (see e.g. this) or flexible division duplexing (FDU).

Some objectives of the study item (RP-213591) are as follows:

In this study, the followings are assumed:

| | |
|---|---|
| • | Duplex enhancement at the gNB side |
| • | Half duplex operation at the UE side |
| • | No restriction on frequency ranges |

The detailed objectives are as follows:

| • | (...) | |
|---|---|---|
| • | Study the subband non-overlapping full duplex and potential enhancements on | |
| | dynamic/flexible TDD (RAN1, RAN4). | |
| | - | Identify possible schemes and evaluate their feasibility and performances |
| | | (RAN1). |
| | - | Study inter-gNB and inter-UE CLI handling and identify solutions to manage |
| | | them (RAN1). |

| | |
|---|---|
| [symbol] | Consider intra-subband CLI and inter-subband CLI in case of the |
| | subband non-overlapping full duplex. |

| | |
|---|---|
| - | Study the performance of the identified schemes as well as the impact on |
| | legacy operation assuming their co-existence in co-channel and adjacent |
| | channels (RAN1). |
| - | Study the feasibility of and impact on RF requirements considering |
| | adjacent-channel co-existence with the legacy operation (RAN4). |
| - | Study the feasibility of and impact on RF requirements considering the |
| | self-interference, the inter-subband CLI, and the inter-operator CLI at gNB |
| | and the inter-subband CLI and inter-operator CLI at UE (RAN4). |

(...)

From the above description of SBFD operation, there are two slot types for both DL and UL transmissions, namely: SBFD slots and Non-SBFD slots. Several SBFD operation modes have been studied including whether time and frequency locations of subbands for SBFD operation are known to the SBFD-aware UE or not. It however has been agreed in 3GPP RAN1 #110 meeting that at least the operation mode with time and frequency locations of subbands for SBFD operation being known to the SBFD-aware UE is prioritized. This means that SBFD slots should be known by the (SBFD-aware) UE in one way or another.

For Cross-link interference (CLI) on the SBFD slots, in RAN1 #110 meeting SBFD introduces a new CLI type, namely co-channel inter-subband CLI. This interference can be better classified as: 1) gNB self-interference; 2) intra-cell UE-to-UE co-channel inter-subband CLI; 3) inter-cell UE-to-UE co-channel inter-subband CLI; 4) gNB-to-gNB co-channel inter-subband CLI.

Besides these new CLI types, in case of different frequency domain partitioning in neighbor cells, the system may also suffer from co-channel intra-subband CLI, i.e. CLI from transmissions on overlapping frequency resources: 5) gNB-to-gNB inter-cell co-channel intra-subband CLI; 6) UE-to-UE inter-cell co-channel intra-subband CLI.

In case of dynamic TDD, flexible slots and static slots are equivalent to SBFD and non-SBFD slots, respectively. However, there is no subbands splitting in dynamic TDD, and gNB is free to schedule DL or UL transmissions on the flexible slots. Therefore, the CLI in case of dynamic TDD are gNB-to-gNB co-channel interference and UE-to-UE co-channel interference.

In RAN1 #111 meeting, the following agreement was made:

Agreement

Study impact and potential enhancements for UL transmissions and DL receptions
across SBFD symbols and non-SBFD symbols, including at least the following:

| | |
|---|---|
| • | PDCCH, scheduled/configured PUCCH/PUSCH/PDSCH, without repetition |
| | in SBFD symbols and non-SBFD symbols |
| • | Scheduled/configured SRS/CSI-RS in SBFD symbols and non-SBFD symbols |
| • | Scheduled/configured TBoMS across SBFD symbols and non-SBFD symbols |
| | with or without repetition |
| • | Multi-PUSCH/PDSCH scheduled by a single DCI in SBFD symbols and |
| | non-SBFD symbols |
| • | Scheduled/configured PDSCH/PUSCH/PUCCH with repetitions across SBFD |
| | symbols and non-SBFD symbols |

Note: Inter-slot/intra-slot/inter-repetition/inter-group frequency hopping with DMRS
bundling of PUSCH/PUCCH, if applicable, is considered.
Examples of potential enhancements include:

| | |
|---|---|
| • | Resource allocation in frequency domain including frequency hopping |
| • | Resource allocation in time domain |
| • | Power domain |
| • | Spatial domain |

FFS: If the PUCCH/PUSCH/PDSCH/PDCCH can be mapped to SBFD and non-SBFD
in the same slot if configured.

From the above description of CLI types, it can be observed that: UL transmissions in SBFD slots (e.g., PUSCH in particular) would be impacted by at least gNB self-interference (1), gNB-to-gNB co-channel inter-subband CLI (4), and gNB-to-gNB inter-cell co-channel intra-subband CLI (5). This significantly impacts coverage of the UL transmissions in SBFD slots. UL transmissions in non-SBFD slots would not be suffering from these interferences, at least for the case when frame structures are aligned across the cells. Therefore, enhancements for improving coverage of PUSCH transmissions in SBFD slots (compared to non-SBFD slots) are needed, especially when the UE is in coverage shortage.

Using TBoMS with repetitions can help improving coverage of PUSCH transmissions. However, there are several limitations with current TBoMS repetition framework when being used for SBFD operation, namely TBoMS repetition does not allow different number of PRBs and frequency allocations across the repetitions. Therefore, it cannot exploit the fact that non-SBFD slots have larger bandwidth and better coverage (lower CLI) compared to SBFD slots for increasing the number of PRBs for the repetitions on SBFD slots. This is critical in SBFD operation given that the bandwidth for UL subband in SBFD slots is limited and shared by many SBFD-aware UEs in the cell. In addition, coexistence with other cells may lead to a scenario of intra-subband co-channel CLI, in which some DL transmissions from other cells may happen in the UL subband of the current cell that uses SBFD. In this case, assuming the exchange of scheduling information among gNBs, the current gNB can avoid such interference by allocating UL transmission that does not overlap with DL transmissions from the other cells, this results in a small number of PRBs may be used for the UL transmission in the SBFD slots compared to non-SBFD slots.

TBoMS repetition always considers the same number of slots for each repetition. Therefore, it cannot exploit the fact that non-SBFD slots have lower CLI compared to SBFD slots for minimizing the number of slots for TBoMS on non-SBFD slots (and improving latency).

Some technical solutions focus on resource determination for Rel-17 TBoMS feature. In particular, issue was raised on how to determine available slots for TBoMS when TBoMS is scheduled across SBFD and non-SBFD slots. The issue discussed in these technical solutions aims at making TBoMS works in SBFD operation. There is no solution has been found on defining a new repetition type used for SBFD operation.

Therefore, a new PUSCH repetition type is needed for using with SBFD operation that takes into account advantages of TBoMS for tackling coverage shortage due to CLI in SBFD slots while also exploiting the characteristics of SBFD operation in terms of bandwidth and CLI difference between SBFD and non-SBFD slots. As mentioned above it can be seen that, the coverage shortage due to CLI in slots of a first slot type (for example, the SBFD) is not solved, and the characteristics of an operation associated with the first slot type in terms of bandwidth and CLI difference between the different types of slots (for example SBFD and non-SBFD slots) is not exploited.

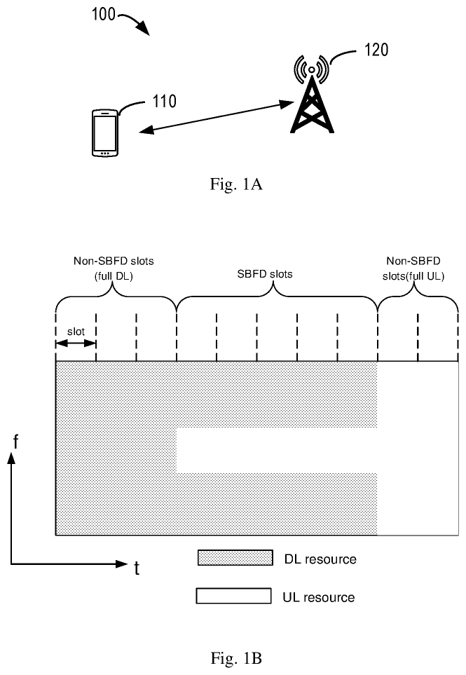

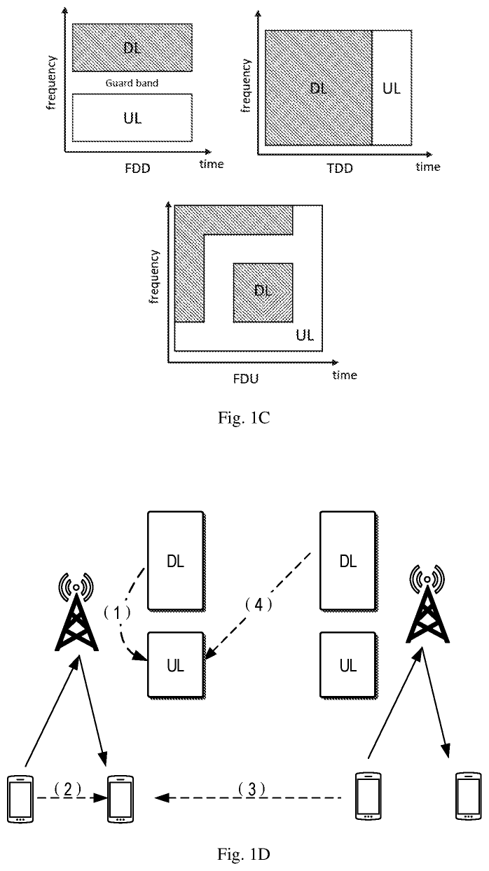

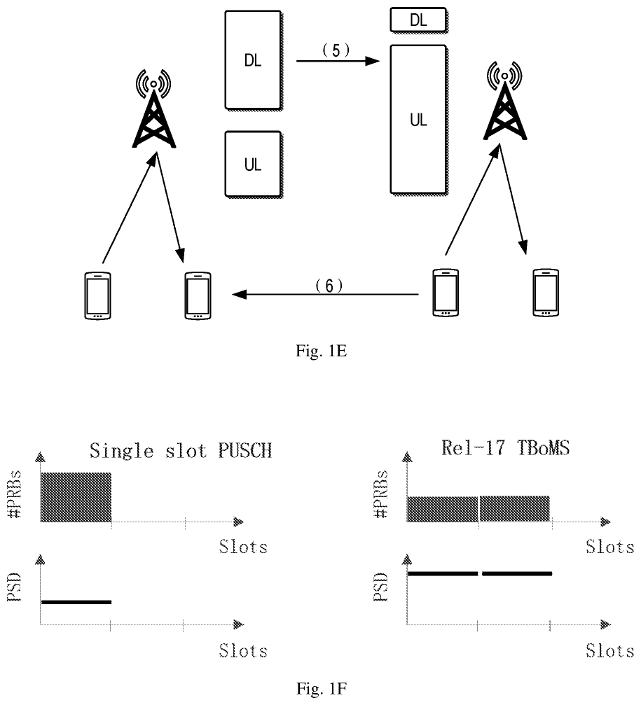

In view of the above, embodiments of the present disclosure provide a solution for repetitions of an uplink transmission. The solution enables enhancements for improving coverage of uplink transmissions. Principle and embodiments of the present disclosure will be described in detail below with reference to the accompanying drawings. Reference is first made to FIG. 1A, which illustrates an example communication system 100 in which embodiments of the present disclosure may be implemented. The system 100 includes terminal device 110 and network device 120. The terminal device 110 is capable of connecting and communicating in an UL or DL with the network device 120 as long as the terminal device 110 located within the corresponding cells. In communication systems, an UL refers to a link in a direction from a terminal device 110 to a network device 120, and a DL refers to a link in a direction from the network device 120 to the terminal device 110. The network device 120 may transmit scheduling information scheduling an uplink transmission to the terminal device 110, and the terminal device 110 may transmit a plurality of repetitions of the uplink transmission to the network device 120.

It is to be understood that the number of network devices 120 and terminal devices 110 is only for the purpose of illustration without suggesting any limitations. The system 100 may include any suitable number of network devices 120 and terminal devices 110 adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Based on what has been discussed above, some contents will be further described below with reference to the accompanying drawings. FIG. 1B illustrates a schematic diagram illustrating SBFD and non-SBFD slots. During the SBFD slots the non-overlapping DL subbands and UL subband(s) both exist, and, during the non-SBFD slots the entire band is used for DL or UL (i.e., legacy/full DL/UL slots). FIG. 1C illustrates a schematic diagram illustrating frequency-time resource partitioning with SBFD as compared to FDD and TDD.

FIG. 1D and FIG. 1E illustrates a schematic diagram illustrating Co-channel interference types in SBFD deployment. With reference to the above mentioned, the gNB self-interference (1), intra-cell UE-to-UE co-channel inter-subband CLI (2), inter-cell UE-to-UE co-channel inter-subband CLI (3) and gNB-to-gNB co-channel inter-subband CLI (4) are shown in FIG. 1D. gNB-to-gNB inter-cell co-channel intra-subband CLI (5) and UE-to-UE inter-cell co-channel intra-subband CLI (6) are shown in FIG. 1E.

FIG. 1F illustrates schematic diagrams illustrating power spectral density gain offered by TBoMS compared to single-slot PUSCH for the same TBS. With reference to FIG. 1F, one main advantage of TBoMS is that it can reduce the number of PRBs needed for transmitting the same transport block size (TBS) compared to the case when the TB is transmitted in a single slot. This helps increasing the energy per resource element (EPRE). Therefore, improving the coverage.

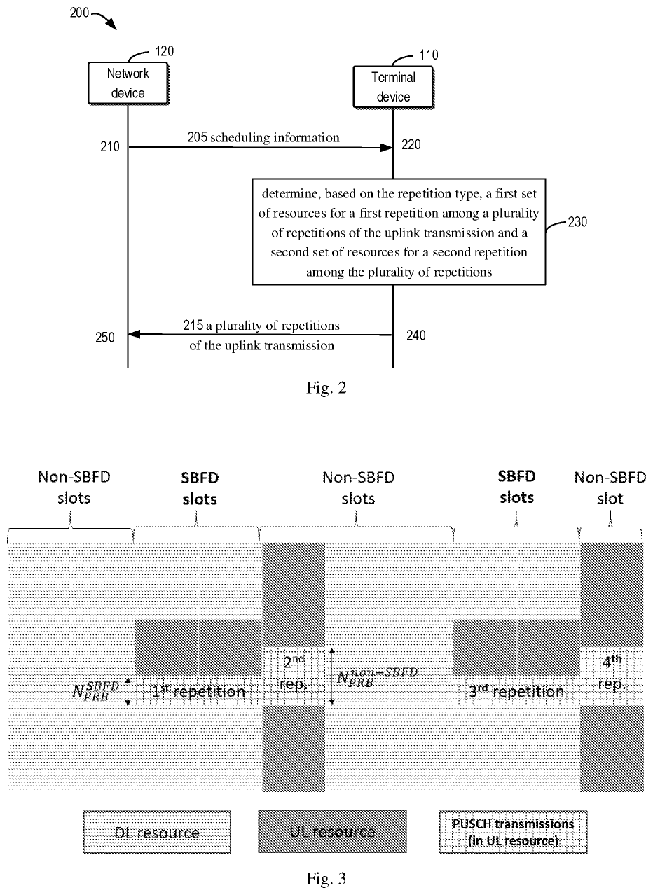

FIG. 2 illustrates a schematic diagram illustrating a process 200 of communication between the terminal device 110 and the network device 120 according to some embodiments of the present disclosure. As shown in FIG. 2, the network device 120 may transmit (210), to the terminal device 110, scheduling information 205 which schedules an uplink transmission to be transmitted by the terminal device 110 using a repetition type. On the terminal device 110 side, the terminal device 110 may receive (220), from the network device 120, the scheduling information 205. The terminal device 110 may determine (230), based on the repetition type, a first set of resources for a first repetition among a plurality of repetitions 215 of the uplink transmission and a second set of resources for a second repetition among the plurality of repetitions. The first set of resources are in a first number of slots with a first slot type and the second set of resources are in a second number of slots with a second slot type. The terminal device 110 may transmit (240), to the network device 120, the plurality of repetitions 215 of the uplink transmission. On the network device 120 side, the network device 120 may receive (250), from the terminal device 110, the plurality of repetitions 215.

In this way, uplink cell coverage is overall improved, and the latency is reduced. In addition, both uplink throughput and resource efficiency are improved.

In some embodiments, on the network device 120 side, prior to transmitting the scheduling information, the network device 120 may transmit, to the terminal device 110, a first indication that the repetition type is applicable for the uplink transmission. On the terminal device 110 side, prior to receiving the scheduling information, the terminal device 110 may receive, from the network device 120, the first indication.

In some embodiments, based on receiving the first indication, the terminal device 110 may determine the repetition type as a default repetition type. For example, the repetition type is supported by default as soon as an UE (an example of the terminal device 110) received the first indication.

In some embodiments, the scheduling information may comprise a second indication for indicating whether the repetition type is to be used (at the terminal device 110) for the uplink transmission.

In some embodiments, based on determining that the second indication is configured to indicate that the repetition type is to be used for the uplink transmission, the terminal device 110 may determine that the uplink transmission is to be transmitted using the repetition type.

In some embodiments, the second indication may comprise a column of a time domain resource assignment (TDRA) table. Additionally, or alternatively, the second indication may comprise a field in downlink control information (DCI).

In some embodiments, based on determining that the terminal device 110 is configured with an operation associated with the first slot type, the terminal device 110 may determine the repetition type as a default repetition type. For example, the repetition type is supported by default when the UE is configured with SBFD operation.

In some embodiments, in order to determine the first set of resources and the second set of resources, the terminal device 110 may determine the first set of resources from the first number of slots, in which the first number is greater than one; and may determine the second set of resources from the second number of slots, in which the second number is equal to one. In some embodiments, the first number is represented by Nₛₗₒₜ.

In some embodiments, the first number is determined based on the number of a plurality of consecutive slots with the first slot type. For example, in some embodiments, Nₛₗₒₜ always equals the number of consecutive SBFD slots.

In some embodiments, the first number is determined based on one plus the number of remaining consecutive slots in the plurality of consecutive slots with the first slot type excluding a first slot for the plurality of repetitions in the event that the first slot is in between the plurality of consecutive slots. For example, in some embodiments, if the first slot of the repetition is a SBFD slot, Nₛₗₒₜ equals the remaining SBFD slots in the group of consecutive SBFD slots plus one (the first slot).

In some embodiments, the first number is determined based on the number of the plurality of consecutive slots with the first slot type in the event that the first slot for the plurality of repetition is of the second slot type. For example, in some embodiments, if the first slot of the repetition is a non-SBFD slot, Nₛₗₒₜ equals the number of consecutive SBFD slots.

In some embodiments, the first number is determined based on the number of slots allocated for transport block processing over multiple slots (TBoMS). For example, in some embodiments, Nₛₗₒₜ equals the number of slots allocated for TBoMS in the current specification, i.e. determined by a column in TDRA table. In this case, it is up to gNB (an example of the network device 120) implementation to ensure that Nₛₗₒₜ≤the number of consecutive SBFD slots, and Nₛₗₒₜ>1.

In some embodiments, on the terminal device 110 side, the first repetition is configured with a first starting symbol index and a first length of allocated resource per slot; the second repetition is configured with a second starting symbol index and a second length of allocated resource per slot. On the network device 120 side, network device 120 may configure the first repetition with a first starting symbol index and a first length of allocated resource per slot above, and may configure the second repetition with a second starting symbol index and a second length of allocated resource per slot above. Additionally, in some embodiments, the first starting symbol index may be the same as the second starting symbol index per slot; or the first length of allocated resource may be the same as the second length of allocated resource per slot. In some other embodiments, the first starting symbol index may be different from the second starting symbol index per slot; or the first length of allocated resource may be different from the second length of allocated resource per slot.

In some embodiments, on the network device 120 side, the network device 120 may indicate the first starting symbol index and the first length of allocated resource via one of a radio resource control (RRC) message or the scheduling information, and the network device 120 may indicate the second starting symbol index and the second length of allocated resource via the other of the RRC message or the scheduling information. In other words, on the terminal device 110 side, the first starting symbol index and the first length of allocated resource above may be indicated via one of a radio resource control (RRC) message or the scheduling information; and the second starting symbol index and the second length of allocated resource above may be indicated via the other of the RRC message or the scheduling information.

In some embodiments, in the event that a first slot of the plurality of repetitions is of the first slot type, the terminal device 110 may determine that the number of physical resource blocks (PRBs) for the second repetition equals to the number of the PRBs for the first repetition scaled by a factor. For example, in some embodiments, if the first slot of the repetitions is a SBFD slot, the number of PRBs used for single-slot repetitions in non-SBFD slots

$$( {N}_{PRB}^{non - SBFD} )$$

equals the number or PRBs used for TBoMS repetitions in SBFD slots

$$( {N}_{PRB}^{SBFD} )$$

scaled by a factor.

In some other embodiments, in the event that the first slot of the plurality of repetitions is of the second slot type, the terminal device 110 may determine that the number of the PRBs for the first repetition equals to the number of the PRBs for the second repetition scaled by the factor. For example, in some embodiments, if the first slot of the repetitions is a non-SBFD slot, the number of PRBs used for TBoMS repetitions in SBFD slots

$$( {N}_{PRB}^{SBFD} )$$

equals the number of PRBs used for single-slot repetitions

$$( {N}_{PRB}^{non - SBFD} )$$

scaled by a factor.

In some embodiments, the factor above may equal to the first number of slots with the first slot type. In some other embodiments, on the terminal device 110 side, the factor above may be indicated via a RRC message or the scheduling information. In other words, on the network device 120 side, the network device 120 may indicate the factor via the RRC message or the scheduling information.

In some embodiments, in the event that a first slot of the plurality of repetitions is of the first slot type, the terminal device 110 may determine that a starting resource block (RB) for the second repetition equals to: a starting RB for the first repetition plus an offset, or a reference RB in frequency domain plus the offset.

Alternatively, in some embodiments, in the event that the first slot of the plurality of repetitions is of the second slot type, the terminal device 110 may determine that the starting RB for the first repetition equals to: a starting RB for the second repetition plus the offset, or the reference RB in frequency domain plus the offset.

In some embodiments, the offset mentioned above may be indicated (by the network device 120) via a RRC message. In some other embodiments, the offset may be indicated via the scheduling information.

In some embodiments, the reference RB may be a starting RB of a bandwidth of the uplink transmission. In some other embodiments, the reference RB may be a starting RB of a subband of the uplink transmission that coexist with at least a subband of a downlink transmission in a slot. In some other embodiments, the reference RB may be a value of a starting RB indicated via a RRC message or the scheduling information.

In some embodiments, the terminal device 110 may calculate, for the plurality of repetitions, a transport block size (TBS) based on at least one allocated resource per slot with the first slot type multiplied by the first number. Additionally, or alternatively, in some embodiments, the terminal device 110 may calculate the TBS based on at least one allocated resource per slot with the second slot type.

In some embodiments, the terminal device 110 may determine a first redundancy version (RV) sequence cycled across a first plurality of repetitions associated with the first slot type among the plurality of repetitions, and may determine a second RV sequence cycled across a second plurality of repetitions associated with the second slot type among the plurality of repetitions. In other words, according to the present disclosure, a redundancy version (RV) sequence cycled across a first plurality of repetitions associated with the first slot type among the plurality of repetitions is a first RV sequence; and a RV sequence cycled across a second plurality of repetitions associated with the second slot type among the plurality of repetitions is a second RV sequence.

In some embodiments, the slots with the first slot type are subband non-overlapping full duplex (SBFD) slots, and the slots with the second slot type are non-SBFD slot. In some other embodiments, the slots with the first slot type are flexible slots, and the slots with the second slot type are static slots.

According to some embodiments of the present disclosure, a new repetition type for SBFD operation is proposed. FIG. 3 illustrates a schematic diagram illustrating the repetition type for SBFD operation according to the present disclosure. With reference to FIG. 3, TBoMS is applied across SBFD slots (in UL subband) as one repetition with a smaller number of PRBs (denoted by

$${N}_{PRB}^{SBFD} ) ,$$

and single-slot PUSCH transmission is applied on each non-SBFD UL slot as another repetition with a higher number of PRBs (denoted by

$${N}_{PRB}^{non - SBFD} , where {N}_{PRB}^{non - SBFD} \geq {N}_{PRB}^{SBFD} ) .$$

The repetitions that use TBoMS across SBFD slots may be referred to as TBoMS repetitions (e.g., 1st and 3rd repetitions in FIG. 3), and the other repetitions as single-slot repetitions (e.g., 2nd and 4th repetitions in FIG. 3).

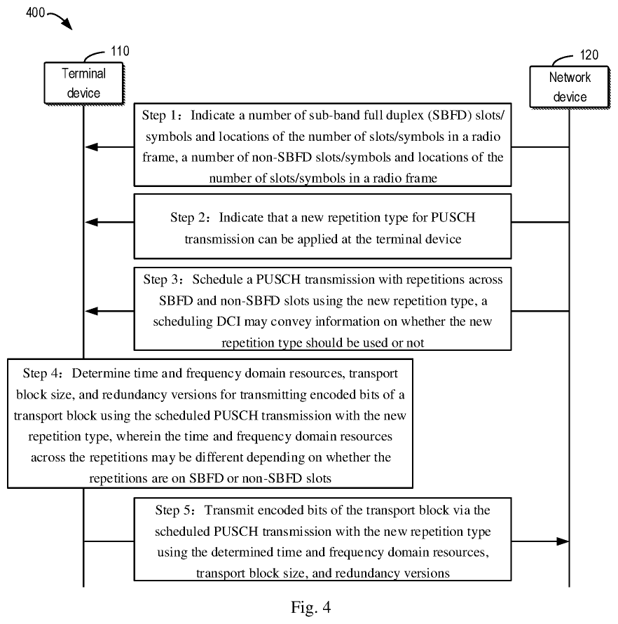

FIG. 4 illustrates a schematic diagram illustrating a process 400 of communication between the terminal device 110 and the network device 120. The terminal device 110 may be UE, and the network device 120 may be called as NW for short. In step 1, the network device 120 indicates, to the terminal device 110, a number of subband full duplex (SBFD) slots/symbols and locations of the number of slots/symbols in a radio frame, and a number of non-SBFD slots/symbols and locations of the number of slots/symbols in a radio frame. Specifically, the network device 120 indicates, and the terminal device 110 receives the following: a frequency band; a number of slots/symbols in which the frequency band is split into multiple subbands and at least one subband is used for DL transmissions and at least one subband is used for UL transmissions, i.e., sub-band full duplex (SBFD) slots/symbols, and locations of the number of slots/symbols in a radio frame; and a number of slots/symbols in which the entire frequency band is used for DL transmissions or UL transmissions, i.e., non-SBFD slots/symbols, and locations of the number of slots/symbols in a radio frame.

In some embodiments, the network device 120 may indicate above via RRC configuration or DCI.

In step 2, the network device 120 indicates that a new repetition type (i.e. the repetition type in the present disclosure) for PUSCH transmission can be applied at the terminal device 110.

Specifically, the network device 120 indicates, and the terminal device 110 receives an indication (referred to as the first indication) that a new repetition type for PUSCH transmission shall be applied at the terminal device 110. In some embodiments, the network device 120 may indicate the first indication via RRC configuration.

In step 3, the network device 120 may schedule a PUSCH transmission with repetitions across SBFD and non-SBFD slots using the new repetition type.

In some embodiments, scheduling DCI may convey information on whether the new repetition type should be used at the terminal device 110 or not. Specifically, the network device 120 indicates, and terminal device 110 receives (e.g., via the scheduling DCI) an indication (referred to as the second indication) concerning whether the new PUSCH repetition type should be used at the terminal device 110 for the PUSCH transmission with repetitions or not, i.e., dynamic indication.

In various embodiments, the indication (the second indication) can be done using different alternatives (Alt. 1-Alt. 3). In some embodiments, as Alt. 1, a new column is added in TDRA table (refer to 3GPP TS 38.214, Clause 6.1.2.1), which indicates that the new repetition type should be applied for each row of the TDRA table or not (e.g., associated with bit 0 or 1). In other words, the second indication may comprise a column of the TDRA table.

In some other embodiments, as Alt. 2, a new field is added in DCI for triggering the applicability of the new repetition type. In other words, the second indication may comprise a field in the DCI.

In some other embodiments, as Alt. 3, the new repetition type is supported by default as soon as the UE received the indication (the first indication) in the step 2, and/or when the UE is configured with SBFD operation.

In step 4, the terminal device 110 determines time and frequency domain resources, transport block size, and redundancy versions for transmitting encoded bits of a transport block using the scheduled PUSCH transmission with the new repetition type, in which the time and frequency domain resources across the repetitions can be different depending on whether the repetitions are on SBFD slots or non-SBFD slots.

Take the terminal device 110 is UE for example, the UE may determine time and frequency domain resources, transport block size, and redundancy versions for transmitting a transport block via multiple repetitions of PUSCH.

For time domain resource determination, a repetition in SBFD slots may use resources from Nₛₗₒₜ slots (referred to as TBoMS repetition), and a repetition in non-SBFD slot may use resource from a single slot (referred to as single-slot repetition).

Nₛₗₒₜ above may be determined from one of the following alternatives (Alt. 1-Alt. 3 below) (Nₛₗₒₜ≤the number of consecutive SBFD slots, and Nₛₗₒₜ>1):
Alt. 1: Nₛₗₒₜ always equals the number of consecutive SBFD slots.
Alt. 2: In some embodiments, if the first slot of the repetition is a SBFD slot, Nₛₗₒₜ equals the remaining SBFD slots in the group of consecutive SBFD slots plus one (the first slot). Otherwise, in some embodiments, the first slot of the repetition is a non-SBFD slot, Nₛₗₒₜ equals the number of consecutive SBFD slots.
Alt. 3: In some embodiments, Nₛₗₒₜ equals the number of slots allocated for TBoMS in the current specification, i.e. determined by a column in TDRA table. In this case, it is up to gNB (an example of the network device 120) implementation to ensure that Nₛₗₒₜ≤the number of consecutive SBFD slots, and Nₛₗₒₜ>1.

Alternatively, or additionally, in some embodiments, the same number of slots used for a TBoMS repetition (Nₛₗₒₜ) and the same location of these slots within a group of consecutive SBFD slots are applied across different groups of consecutive SBFD slots. E.g., a TBoMS repetition is always transmitted across the first and third slots of a group of 3 consecutive SBFD slots.

In some embodiments, the same starting symbol index (S) and length of the allocated resource per slot (L) indicated via scheduling DCI are applied across the slots of TBoMS repetitions and the slots of single-slot repetitions.

Alternatively, in some other embodiments, the S and the L above can be different between the slots in TBoMS repetitions and the slots of single-slot repetitions. For example, the S and the L for the slots in TBoMS repetitions is preconfigured in RRC and the scheduling DCI only indicates the S and the L for the slots of single-slot repetitions, or vice versa.

For frequency domain resource determination, in some embodiments, if the first slot of the repetitions is a SBFD slot, the number of PRBs used for single-slot repetitions in non-SBFD slots

$$( {N}_{PRB}^{non - SBFD} )$$

equals the number of PRBs used for TBoMS repetitions in SBFD slots

$$( {N}_{PRB}^{SBFD} )$$

scaled by a factor.

In one example, the factor equals the number of slots used for TBoMS repetition during consecutive SBFD slots, i.e.,

$${N}_{PRB}^{non - SBFD} = {N}_{PRB}^{SBFD} \times {N}_{slot} .$$

This results in the same resource across TBoMS repetitions and single-slot repetitions, which help simplifying the TBS determination.

In some other embodiments, if the first slot of the repetitions is a non-SBFD slot, the number of PRBs used for TBoMS repetitions in SBFD slots

$$( {N}_{PRB}^{SBFD} )$$

equals the number of PRBs used for single-slot repetitions

$$( {N}_{PRB}^{non - SBFD} )$$

scaled by a factor.

In one example, the factor equals one divided by the number of slots used for TBoMS repetition during consecutive SBFD slots, i.e.,

$${N}_{PRB}^{non - SBFD} = {N}_{PRB}^{SBFD} \times 1 / {N}_{slot} .$$

The terminal device 110 may also determine the transport block size (TBS). For TBS calculation, in some embodiments, Alt. 1: the TBS is calculated based on the allocated resource per SBFD slot multiplied by Nₛₗₒₜ. In some other embodiments, Alt. 2: the TBS is calculated based on the allocated resource per non-SBFD slot. Alt. 1 and Alt. 2 above will result in the same TBS if

$${N}_{PRB}^{non - SBFD} = {N}_{PRB}^{SBFD} \times {N}_{slot} .$$

The terminal device 110 may determine redundancy version. For redundancy version determination, in some embodiments, legacy RV sequence is used. RVs are cycled across all repetitions including TBoMS repetitions and single-slot repetitions using the legacy sequence. In some other embodiments, two RV sequences are configured. RVs are cycled across TBoMS repetitions using one sequence (e.g., a new sequence different from the legacy RV sequence) and RVs are cycled across single-slot repetitions using another sequence (e.g., the legacy sequence).

In step 5, the terminal device 110 may transmit encoded bits of the transport block via the scheduled PUSCH transmission with the new repetition type using the determined time and frequency domain resources, transport block size, and redundancy versions.

Specifically, for example, the UE transmits and NW (network) receives the encoded bits of the transport block via the scheduled PUSCH transmission with the new repetition type using the determined time and frequency domain resources, transport block size, and redundancy versions.

In some embodiments, the step 1 and step 2 may be interchangeable or mergeable.

In some embodiments, the terminal device 110 may report its capability of supporting the new repetition type to the network device 120 as a preliminary step.

In some embodiments, for dynamic TDD scenario, the SBFD slots may be replaced by flexible slots of the dynamic TDD, and the non-SBFD slots may be replaced by static slots of the dynamic TDD.

According to the embodiments of the present disclosure, the terminal device 110 (for example the UE) receives from network (NW) an indication (e.g., via RRC and/or DCI) for letting the UE to determine time and frequency domain resources, transport block size, and redundancy versions for transmitting a transport block via multiple repetitions of PUSCH. At least the time (also the frequency in some embodiments) domain resources across the repetitions are different depending on whether the repetitions are on SBFD or non-SBFD slots. On the UE side, the UE determines the time and frequency domain resources, the transport block size, and the redundancy versions for transmitting a transport block via multiple repetitions of PUSCH. In this way, a combination of TBoMS and single-slot PUSCH transmission allows narrower PUSCH allocation (in term of number of PRBs) in SBFD slots which results in more users multiplexed in frequency domain (in the UL subband of SBFD slots) and overall improved UL cell coverage. At the same time, having a single-slot PUSCH transmission in the non-SBFD slot reduces the latency and improves UL throughput and resource efficiency as compared to the case where TBoMS would have been applied.

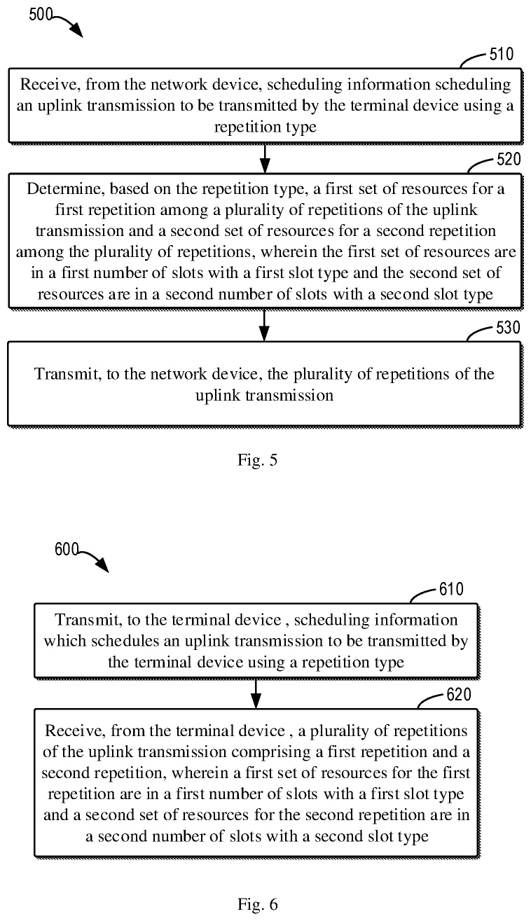

FIG. 5 illustrates a schematic diagram illustrating a method 500 implemented at a terminal device according to some other embodiments of the present disclosure. As shown in FIG. 5, at block 510, the terminal device 110 may receive, from the network device 120, scheduling information scheduling an uplink transmission to be transmitted by the terminal device 110 using a repetition type. At block 520, the terminal device 110 may determine, based on the repetition type, a first set of resources for a first repetition among a plurality of repetitions of the uplink transmission and a second set of resources for a second repetition among the plurality of repetitions. The first set of resources are in a first number of slots with a first slot type and the second set of resources are in a second number of slots with a second slot type. At block 530, the terminal device 110 may transmit, to the network device 120, the plurality of repetitions of the uplink transmission.

In some embodiments, prior to receiving the scheduling information, the terminal device 110 may receive, from the network device 120, a first indication that the repetition type is applicable for the uplink transmission.

In some embodiments, based on receiving the first indication, the terminal device 110 may determine the repetition type as a default repetition type.

In some embodiments, the scheduling information may comprise a second indication for indicating whether the repetition type is to be used for the uplink transmission.

In some embodiments, based on determining that the second indication is configured to indicate that the repetition type is to be used for the uplink transmission, the terminal device 110 may determine that the uplink transmission is to be transmitted using the repetition type.

In some embodiments, the second indication may comprise at least one of the following: a column of a time domain resource assignment (TDRA) table; or a field in downlink control information (DCI).

In some embodiments, based on determining that the terminal device 110 is configured with an operation associated with the first slot type, the terminal device 110 may determine the repetition type as a default repetition type.

In some embodiments, in order to determine the first set of resources and the second set of resources, the terminal device 110 may determine the first set of resources from the first number of slots, in which the first number is greater than one; and determine the second set of resources from the second number of slots, in which the second number is equal to one.

In some embodiments, the first number may be determined based on one of the following: the number of a plurality of consecutive slots with the first slot type; one plus the number of remaining consecutive slots in the plurality of consecutive slots with the first slot type excluding a first slot for the plurality of repetitions in the event that the first slot is in between the plurality of consecutive slots; the number of the plurality of consecutive slots with the first slot type in the event that the first slot for the plurality of repetition is of the second slot type; or the number of slots allocated for transport block processing over multiple slots (TBoMS).

In some embodiments, the first repetition is configured with a first starting symbol index and a first length of allocated resource per slot, and the second repetition is configured with a second starting symbol index and a second length of allocated resource per slot. In this event, the first starting symbol index is the same as the second starting symbol index per slot. Alternatively or additionally, the first length of allocated resource is the same as the second length of allocated resource per slot.

In some embodiments, the first repetition is configured with a first starting symbol index and a first length of allocated resource per slot, and the second repetition is configured with a second starting symbol index and a second length of allocated resource per slot. In this event, the first starting symbol index is different from the second starting symbol index per slot. Alternatively, or additionally, the first length of allocated resource is different from the second length of allocated resource per slot.

In some embodiments, the first starting symbol index and the first length of allocated resource may be indicated via one of a radio resource control (RRC) message or the scheduling information; and the second starting symbol index and the second length of allocated resource may be indicated via the other of the RRC message or the scheduling information.

In some embodiments, in the event that a first slot of the plurality of repetitions is of the first slot type, the terminal device 110 may determine that the number of physical resource blocks (PRBs) for the second repetition equals to the number of the PRBs for the first repetition scaled by a factor; or in the event that the first slot of the plurality of repetitions is of the second slot type, the terminal device 110 may determine that the number of the PRBs for the first repetition equals to the number of the PRBs for the second repetition scaled by the factor.

In some embodiments, the factor equals to the first number of slots with the first slot type; or the factor is indicated via a RRC message or the scheduling information.

In some embodiments, in the event that a first slot of the plurality of repetitions is of the first slot type, the terminal device 110 may determine that a starting resource block (RB) for the second repetition equals to: a starting RB for the first repetition plus an offset, or a reference RB in frequency domain plus the offset; or in the event that the first slot of the plurality of repetitions is of the second slot type, the terminal device 110 may determine that the starting RB for the first repetition equals to: a starting RB for the second repetition plus the offset, or the reference RB in frequency domain plus the offset.

In some embodiments, the offset may be indicated via a RRC message or the scheduling information.

In some embodiments, the reference RB is one of: a starting RB of a bandwidth of the uplink transmission; a starting RB of a subband of the uplink transmission that coexist with at least a subband of a downlink transmission in a slot; or a value of a starting RB indicated via a RRC message or the scheduling information.

In some embodiments, the terminal device 110 may calculate, for the plurality of repetitions, a transport block size (TBS) based on at least one allocated resource per slot with the first slot type multiplied by the first number. In some other embodiments, the terminal device 110 may calculate the TBS based on at least one allocated resource per slot with the second slot type.

In some embodiments, the terminal device 110 may determine a first redundancy version (RV) sequence cycled across a first plurality of repetitions associated with the first slot type among the plurality of repetitions; and may determine a second RV sequence cycled across a second plurality of repetitions associated with the second slot type among the plurality of repetitions.

In some embodiments, the slots with the first slot type are subband non-overlapping full duplex (SBFD) slots or flexible slots; and the slots with the second slot type are non-SBFD slot or static slots.

FIG. 6 illustrates a schematic diagram illustrating a method 600 implemented at the network device 120 according to some other embodiments of the present disclosure. As shown in FIG. 6, at block 610, the network device 120 may transmit, to the terminal device 110, scheduling information which schedules an uplink transmission to be transmitted by the terminal device 110 using a repetition type. At block 620, the network device 120 may receive, from the terminal device 110, a plurality of repetitions of the uplink transmission comprising a first repetition and a second repetition. A first set of resources for the first repetition are in a first number of slots with a first slot type and a second set of resources for the second repetition are in a second number of slots with a second slot type.

In some embodiments, prior to transmitting the scheduling information, the network device 120 may transmit, to the terminal device 110, a first indication that the repetition type is applicable for the uplink transmission.

In some embodiments, the scheduling information comprises a second indication for indicating whether the repetition type is to be used at the terminal device 110 for the uplink transmission.

In some embodiments, the second indication comprises at least one of the following: a column of a time domain resource assignment (TDRA) table; or a field in downlink control information (DCI).

In some embodiments, the first number is greater than one. Additionally, or alternatively, the second number is equal to one.

In some embodiments, the first number is determined based on one of the following: the number of a plurality of consecutive slots with the first slot type; one plus the number of remaining consecutive slots in the plurality of consecutive slots with the first slot type excluding a first slot for the plurality of repetitions in the event that the first slot is in between the plurality of consecutive slots; the number of the plurality of consecutive slots with the first slot type in the event that the first slot for the plurality of repetition is of the second slot type; or the number of slots allocated for transport block processing over multiple slots (TBoMS).

In some embodiments, the network device 120 may configure the first repetition with a first starting symbol index and a first length of allocated resource per slot; configure the second repetition with a second starting symbol index and a second length of allocated resource per slot. In such a case, the first starting symbol index is the same as the second starting symbol index per slot. Alternatively or additionally, the first length of allocated resource is the same as the second length of allocated resource per slot.

In some embodiments, the network device 120 may configure the first repetition with a first starting symbol index and a first length of allocated resource per slot; configure the second repetition with a second starting symbol index and a second length of allocated resource per slot. In such a case, the first starting symbol index is different from the second starting symbol index per slot. Alternatively, or additionally, the first length of allocated resource is different from the second length of allocated resource per slot.

In some embodiments, the network device 120 may indicate the first starting symbol index and the first length of allocated resource via one of a radio resource control (RRC) message or the scheduling information; and indicate the second starting symbol index and the second length of allocated resource via the other of the RRC message or the scheduling information.

In some embodiments, in the event that a first slot of the plurality of repetitions is of the first slot type, the number of physical resource blocks (PRBs) for the second repetition equals to the number of the PRBs for the first repetition scaled by a factor. In some embodiments, in the event that the first slot of the plurality of repetitions is of the second slot type, the number of the PRBs for the first repetition equals to the number of the PRBs for the second repetition scaled by the factor.

In some embodiments, the factor equals to the first number of slots with the first slot type. In some embodiments, the network device 120 indicate the factor via a RRC message or the scheduling information.

In some embodiments, in the event that a first slot of the plurality of repetitions is of the first slot type, the network device 120 may determine that a starting resource block (RB) for the second repetition equals to: a starting RB for the first repetition plus an offset, or a reference RB in frequency domain plus the offset. In some embodiments, in the event that the first slot of the plurality of repetitions is of the second slot type, the network device 120 may determine that the starting RB for the first repetition equals to: a starting RB for the second repetition plus the offset, or the reference RB in frequency domain plus the offset.

In some embodiments, the network device 120 may indicate the offset via a RRC message or the scheduling information.

In some embodiments, the reference RB is one of: a starting RB of a bandwidth of the uplink transmission; a starting RB of a subband of the uplink transmission that coexist with at least a subband of a downlink transmission in a slot; or a value of a starting RB indicated via a RRC message or the scheduling information.

In some embodiments, a transport block size (TBS) for the plurality of repetitions may be calculated based on at least one allocated resource per slot with the first slot type multiplied by the first number. In some embodiments, the TBS may be calculated based on at least one allocated resource per slot with the second slot type.

In some embodiments, a redundancy version (RV) sequence cycled across a first plurality of repetitions associated with the first slot type among the plurality of repetitions is a first RV sequence; and a RV sequence cycled across a second plurality of repetitions associated with the second slot type among the plurality of repetitions is a second RV sequence.

In some embodiments, the slots with the first slot type is subband non-overlapping full duplex (SBFD) slots or flexible slots; and the slots with the second slot type is non-SBFD slot or static slots.

In some embodiments, an apparatus capable of performing any of the method 500 (for example, the terminal device 110) may comprise means for performing the respective steps of the method 500. The means may be implemented in any suitable form. For example, the means may be implemented in a circuitry or software module.

In some embodiments, the apparatus comprises means for receiving, from the network device 120, scheduling information scheduling an uplink transmission to be transmitted by the terminal device 110 using a repetition type; means for determining, based on the repetition type, a first set of resources for a first repetition among a plurality of repetitions of the uplink transmission and a second set of resources for a second repetition among the plurality of repetitions, in which the first set of resources are in a first number of slots with a first slot type and the second set of resources are in a second number of slots with a second slot type; and means for transmitting, to the network device 120, the plurality of repetitions of the uplink transmission.

In some embodiments, the apparatus further comprises means for prior to receiving the scheduling information, receiving, from the network device 120, a first indication that the repetition type is applicable for the uplink transmission.

In some embodiments, the apparatus further comprises means for based on receiving the first indication, determining the repetition type as a default repetition type.

In some embodiments, the scheduling information comprises a second indication for indicating whether the repetition type is to be used for the uplink transmission.

In some embodiments, the apparatus further comprises means for based on determining that the second indication is configured to indicate that the repetition type is to be used for the uplink transmission, determining that the uplink transmission is to be transmitted using the repetition type.

In some embodiments, the second indication comprises at least one of the following: a column of a time domain resource assignment (TDRA) table; or a field in downlink control information (DCI).

In some embodiments, the apparatus further comprises means for based on determining that the terminal device 110 is configured with an operation associated with the first slot type, determining the repetition type as a default repetition type.

In some embodiments, the means for determining the first set of resources and the second set of resources comprises means for determining the first set of resources from the first number of slots, in which the first number is greater than one; and means for determining the second set of resources from the second number of slots, in which the second number is equal to one.

In some embodiments, the first number is determined based on one of the following: the number of a plurality of consecutive slots with the first slot type; one plus the number of remaining consecutive slots in the plurality of consecutive slots with the first slot type excluding a first slot for the plurality of repetitions in the event that the first slot is in between the plurality of consecutive slots; the number of the plurality of consecutive slots with the first slot type in the event that the first slot for the plurality of repetition is of the second slot type; or the number of slots allocated for transport block processing over multiple slots (TBoMS).

In some embodiments, the first repetition is configured with a first starting symbol index and a first length of allocated resource per slot; the second repetition is configured with a second starting symbol index and a second length of allocated resource per slot; and

at least one of the following: the first starting symbol index is the same as the second starting symbol index per slot; or the first length of allocated resource is the same as the second length of allocated resource per slot.

In some embodiments, the first repetition is configured with a first starting symbol index and a first length of allocated resource per slot; the second repetition is configured with a second starting symbol index and a second length of allocated resource per slot; and at least one of the following: the first starting symbol index is different from the second starting symbol index per slot; or the first length of allocated resource is different from the second length of allocated resource per slot.

In some embodiments, the first starting symbol index and the first length of allocated resource are indicated via one of a radio resource control (RRC) message or the scheduling information; and the second starting symbol index and the second length of allocated resource are indicated via the other of the RRC message or the scheduling information.

In some embodiments, the apparatus further comprises means for in the event that a first slot of the plurality of repetitions is of the first slot type, determining that the number of physical resource blocks (PRBs) for the second repetition equals to the number of the PRBs for the first repetition scaled by a factor; or in the event that the first slot of the plurality of repetitions is of the second slot type, determine that the number of the PRBs for the first repetition equals to the number of the PRBs for the second repetition scaled by the factor.

In some embodiments, the factor equals to the first number of slots with the first slot type; or the factor is indicated via a RRC message or the scheduling information.

In some embodiments, the apparatus further comprises one of the following: means for in the event that a first slot of the plurality of repetitions is of the first slot type, determining that a starting resource block (RB) for the second repetition equals to: a starting RB for the first repetition plus an offset, or a reference RB in frequency domain plus the offset; or means for in the event that the first slot of the plurality of repetitions is of the second slot type, determining that the starting RB for the first repetition equals to: a starting RB for the second repetition plus the offset, or the reference RB in frequency domain plus the offset.

In some embodiments, the offset is indicated via a RRC message or the scheduling information.

In some embodiments, the reference RB is one of: a starting RB of a bandwidth of the uplink transmission; a starting RB of a subband of the uplink transmission that coexist with at least a subband of a downlink transmission in a slot; or a value of a starting RB indicated via a RRC message or the scheduling information.

In some embodiments, the apparatus further comprises one of the following: means for calculating, for the plurality of repetitions, a transport block size (TBS) based on at least one allocated resource per slot with the first slot type multiplied by the first number; or means for calculating the TBS based on at least one allocated resource per slot with the second slot type.

In some embodiments, the apparatus further comprises means for determining a first redundancy version (RV) sequence cycled across a first plurality of repetitions associated with the first slot type among the plurality of repetitions; and means for determining a second RV sequence cycled across a second plurality of repetitions associated with the second slot type among the plurality of repetitions.

In some embodiments, the slots with the first slot type are subband non-overlapping full duplex (SBFD) slots or flexible slots; and the slots with the second slot type are non-SBFD slot or static slots.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing any of the method 600 (for example, the network device 120) may comprise means for performing the respective steps of the method 600. The means may be implemented in any suitable form. For example, the means may be implemented in a circuitry or software module.

In some embodiments, the apparatus comprises: means for transmitting, to the terminal device 110, scheduling information which schedules an uplink transmission to be transmitted by the terminal device 110 using a repetition type; and means for receiving, from the terminal device 110, a plurality of repetitions of the uplink transmission comprising a first repetition and a second repetition, in which a first set of resources for the first repetition are in a first number of slots with a first slot type and a second set of resources for the second repetition are in a second number of slots with a second slot type.

In some embodiments, the apparatus further comprises means for prior to transmitting the scheduling information, transmitting, to the terminal device 110, a first indication that the repetition type is applicable for the uplink transmission.

In some embodiments, the scheduling information comprises a second indication for indicating whether the repetition type is to be used at the terminal device 110 for the uplink transmission.

In some embodiments, the second indication comprises at least one of the following: a column of a time domain resource assignment (TDRA) table; or a field in downlink control information (DCI).

In some embodiments, at least one of the following: the first number is greater than one; or the second number is equal to one.

In some embodiments, the first number is determined based on one of the following: the number of a plurality of consecutive slots with the first slot type; one plus the number of remaining consecutive slots in the plurality of consecutive slots with the first slot type excluding a first slot for the plurality of repetitions in the event that the first slot is in between the plurality of consecutive slots; the number of the plurality of consecutive slots with the first slot type in the event that the first slot for the plurality of repetition is of the second slot type; or the number of slots allocated for transport block processing over multiple slots (TBoMS).

In some embodiments, the apparatus further comprises means for configuring the first repetition with a first starting symbol index and a first length of allocated resource per slot; means for configuring the second repetition with a second starting symbol index and a second length of allocated resource per slot; and at least one of the following: the first starting symbol index is the same as the second starting symbol index per slot; or the first length of allocated resource is the same as the second length of allocated resource per slot.

In some embodiments, the apparatus further comprises means for configuring the first repetition with a first starting symbol index and a first length of allocated resource per slot; means for configuring the second repetition with a second starting symbol index and a second length of allocated resource per slot; and at least one of the following: the first starting symbol index is different from the second starting symbol index per slot; or the first length of allocated resource is different from the second length of allocated resource per slot.

In some embodiments, the apparatus further comprises means for indicating the first starting symbol index and the first length of allocated resource via one of a radio resource control (RRC) message or the scheduling information; and means for indicating the second starting symbol index and the second length of allocated resource via the other of the RRC message or the scheduling information.

In some embodiments, at least one of the following: in the event that a first slot of the plurality of repetitions is of the first slot type, the number of physical resource blocks (PRBs) for the second repetition equals to the number of the PRBs for the first repetition scaled by a factor; or in the event that the first slot of the plurality of repetitions is of the second slot type, the number of the PRBs for the first repetition equals to the number of the PRBs for the second repetition scaled by the factor.

In some embodiments, the factor equals to the first number of slots with the first slot type; or the apparatus further comprises means for indicating the factor via a RRC message or the scheduling information.

In some embodiments, the apparatus further comprises one of the following: means for in the event that a first slot of the plurality of repetitions is of the first slot type, determining that a starting resource block (RB) for the second repetition equals to: a starting RB for the first repetition plus an offset, or a reference RB in frequency domain plus the offset; or means for in the event that the first slot of the plurality of repetitions is of the second slot type, determining that the starting RB for the first repetition equals to: a starting RB for the second repetition plus the offset, or the reference RB in frequency domain plus the offset.

In some embodiments, the apparatus further comprises means for indicating the offset via a RRC message or the scheduling information.

In some embodiments, the reference RB is one of: a starting RB of a bandwidth of the uplink transmission; a starting RB of a subband of the uplink transmission that coexist with at least a subband of a downlink transmission in a slot; or a value of a starting RB indicated via a RRC message or the scheduling information.

In some embodiments, at least one of the following is applied: a transport block size (TBS) for the plurality of repetitions being calculated based on at least one allocated resource per slot with the first slot type multiplied by the first number; or the TBS being calculated based on at least one allocated resource per slot with the second slot type.

In some embodiments, a redundancy version (RV) sequence cycled across a first plurality of repetitions associated with the first slot type among the plurality of repetitions is a first RV sequence; and a RV sequence cycled across a second plurality of repetitions associated with the second slot type among the plurality of repetitions is a second RV sequence.

In some embodiments, the slots with the first slot type is subband non-overlapping full duplex (SBFD) slots or flexible slots; and the slots with the second slot type is non-SBFD slot or static slots.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

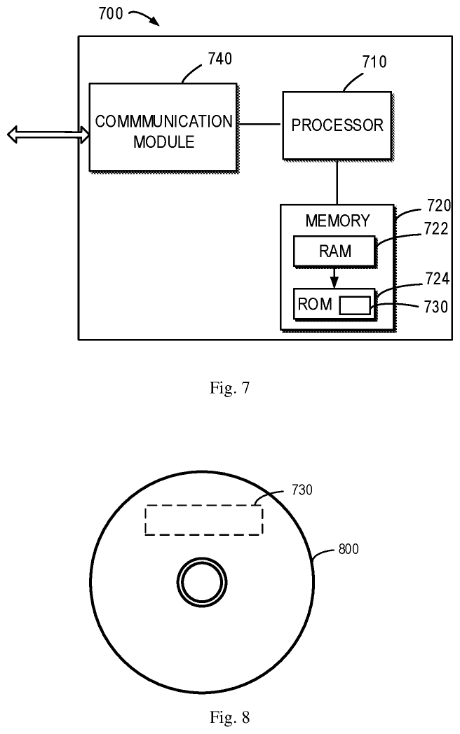

FIG. 7 is a simplified block diagram of a device 700 that is suitable for implementing embodiments of the present disclosure. The device 700 may be provided to implement the communication device, for example the terminal device 110, or the network device 120 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 820. The processor 710 may perform any suitable actions and processing by loading the program 730 into the RAM 820.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or the method 600 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-42. (canceled)

43. A terminal device comprising:
at least one processor; and
at least one memory storing instructions that, when executed by the at least one processor, cause the terminal device at least to:
receive, from a network device, scheduling information scheduling an uplink transmission to be transmitted by the terminal device using a repetition type;
determine, based on the repetition type, a first set of resources for one repetition among a plurality of repetitions of the uplink transmission and a second set of resources for another repetition among the plurality of repetitions, wherein the first set of resources are in a first number of slots with a first slot type and the second set of resources are in a second number of slots with a second slot type; and
transmit, to the network device, the plurality of repetitions of the uplink transmission.

44. The terminal device of claim 43, wherein the terminal device is further caused to:
prior to receiving the scheduling information, receive, from the network device, a first indication that the repetition type is applicable for the uplink transmission.

45. The terminal device of claim 44, wherein the terminal device is further caused to:
based on receiving the first indication, determine the repetition type as a default repetition type.

46. The terminal device of claim 43, wherein:
the scheduling information comprises a second indication for indicating whether the repetition type is to be used for the uplink transmission.

47. The terminal device of claim 43, wherein the terminal device is further caused to:
based on determining that the terminal device is configured with an operation associated with the first slot type, determine the repetition type as a default repetition type.

48. The terminal device of claim 43, wherein the terminal device is caused to determine the first set of resources and the second set of resources by:
determining the first set of resources from the first number of slots, wherein the first number is greater than one; and
determining the second set of resources from the second number of slots, wherein the second number is equal to one.

49. The terminal device of any of claim 43, wherein:
the one repetition is configured with a first starting symbol index and a first length of allocated resource per slot;
the other repetition is configured with a second starting symbol index and a second length of allocated resource per slot; and
wherein at least one of the following: the first starting symbol index is the same as the second starting symbol index per slot; or the first length of allocated resource is the same as the second length of allocated resource per slot.

50. The terminal device of claim 43, wherein:
the one repetition is configured with a first starting symbol index and a first length of allocated resource per slot;
the other repetition is configured with a second starting symbol index and a second length of allocated resource per slot; and
wherein at least one of the following: the first starting symbol index is different from the second starting symbol index per slot; or the first length of allocated resource is different from the second length of allocated resource per slot.

51. The terminal device of claim 43, wherein the terminal device is further caused to:
in the event that a first slot of the plurality of repetitions is of the first slot type, determine that the number of physical resource blocks, PRBs, for the other repetition equals the number of the PRBs for the one repetition scaled by a factor; or
in the event that the first slot of the plurality of repetitions is of the second slot type, determine that the number of the PRBs for the one repetition equals the number of the PRBs for the other repetition scaled by the factor.

52. The terminal device of claim 43, wherein the terminal device is further caused to at least one of the following:
in the event that a first slot of the plurality of repetitions is of the first slot type, determine that a starting resource block, RB, for the other repetition equals: a starting RB for the one repetition plus an offset, or a reference RB in frequency domain plus the offset; or
in the event that the first slot of the plurality of repetitions is of the second slot type, determine that the starting RB for the one repetition equals: a starting RB for the other repetition plus the offset, or the reference RB in frequency domain plus the offset.

53. The terminal device of claim 52, wherein the offset is indicated via a radio resource control, RRC, message or the scheduling information.

54. The terminal device of claim 52, wherein the reference RB is one of:
a starting RB of a bandwidth of the uplink transmission;
a starting RB of a subband of the uplink transmission that coexist with at least a subband of a downlink transmission in a slot; or
a value of a starting RB indicated via a RRC message or the scheduling information.

55. The terminal device of claim 43, wherein the terminal device is further caused to at least one of the following:
calculate, for the plurality of repetitions, a transport block size, TBS, based on at least one allocated resource per slot with the first slot type multiplied by the first number; or
calculate the TBS based on at least one allocated resource per slot with the second slot type.

56. The terminal device of claim 43, wherein the terminal device is further caused to:
determine a first redundancy version, RV, sequence cycled across a first plurality of repetitions associated with the first slot type among the plurality of repetitions; and
determine a second RV sequence cycled across a second plurality of repetitions associated with the second slot type among the plurality of repetitions.

57. The terminal device of claim 43, wherein:
the slots with the first slot type are sub-band full duplex, SBFD, slots or flexible slots; and
the slots with the second slot type are non-SBFD slot or static slots.

58. A network device comprising:
at least one processor; and
at least one memory storing instructions that, when executed by the at least one processor, cause the network device at least to:
transmit, to the terminal device, scheduling information which schedules an uplink transmission to be transmitted by the terminal device using a repetition type; and
receive, from the terminal device, a plurality of repetitions of the uplink transmission comprising one repetition and another repetition, wherein a first set of resources for the one repetition are in a first number of slots with a first slot type and a second set of resources for the other repetition are in a second number of slots with a second slot type.

59. The network device of claim 58, wherein the network device is further caused to:
prior to transmitting the scheduling information, transmit, to the terminal device, a first indication that the repetition type is applicable for the uplink transmission.

60. The network device of claim 58, wherein:
configure the first repetition with a first starting symbol index and a first length of allocated resource per slot;
configure the second repetition with a second starting symbol index and a second length of allocated resource per slot; and
wherein at least one of the following: the first starting symbol index is the same as the second starting symbol index per slot; or the first length of allocated resource is the same as the second length of allocated resource per slot.

61. The network device of claim 58, wherein the network device is further caused to:
configure the first repetition with a first starting symbol index and a first length of allocated resource per slot;
configure the second repetition with a second starting symbol index and a second length of allocated resource per slot; and
wherein at least one of the following: the first starting symbol index is different from the second starting symbol index per slot; or the first length of allocated resource is different from the second length of allocated resource per slot.

62. A method comprising:
receiving, at a terminal device and from a network device, scheduling information scheduling an uplink transmission to be transmitted by the terminal device using a repetition type;
determining, based on the repetition type, a first set of resources for one repetition among a plurality of repetitions of the uplink transmission and a second set of resources for another repetition among the plurality of repetitions, wherein the first set of resources are in a first number of slots with a first slot type and the second set of resources are in a second number of slots with a second slot type; and
transmitting, to the network device, the plurality of repetitions of the uplink transmission.
